(19) United States
(12) Patent Application Publication
(10) Pub. No.: US 2014/0353244 A1
(43) Pub. Date: Dec. 4, 2014

(54) METHOD FOR THE PRODUCTION OF A HYDROPHILIC POLYMER MEMBRANE AND POLYMER MEMBRANE

(71) Applicant: Ewald Dörken AG, Herdecke (DE)

(72) Inventors: Jörn Schröer, Herdecke (DE); Daniel Placke, Dortmund (DE)

(21) Appl. No.: 14/372,569

(22) PCT Filed: Jan. 15, 2013
(86) PCT No.: PCT/EP2013/000097

§ 371 Date: Jul. 16, 2014

(30) Foreign Application Priority Data
Jan. 16, 2012 (DE) 10 2012 000 576.8
Jan. 27, 2012 (DE) 10 2012 001 524.0

(51) Int. Cl. B01D 71/26; B29D 7/01; B01D 67/00; B01D 69/02; B01D 61/14

(52) U.S. Cl. CPC B01D 71/26; B01D 69/02; B01D 61/14; B01D 67/0086; B29D 7/01; B29L 2007/00
USPC 210/510.1; 264/41

(57) ABSTRACT

A method for the production of a hydrophilic polymer membrane (1), in particular for the production of a porous membrane for filtration or for use in functional textiles, whereby at least one hydrophilization additive (3) is used as a starting material for the membrane production, optionally, at least one additional aggregate, is/are admixed into an in particular hydrophobic polymer membrane material (2), whereby the membrane material (4) that has the hydrophilization additive (3) and optionally the additional aggregate is extruded to form a polymer film (5) that is charged with the hydrophilization additive (3) and optionally the additional aggregate, and whereby the polymer film (5) is stretched, in particular in a monoaxial and/or biaxial manner for pore formation.

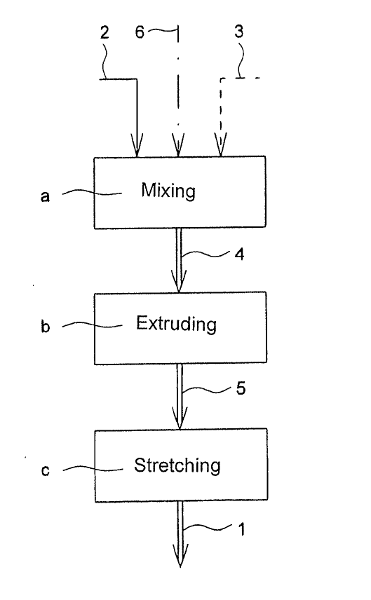

### BACKGROUND OF THE INVENTION

1. Field of the Invention

The invention relates to a method for the production of a hydrophilic polymer membrane, in particular for the production of a porous membrane for filtration or for use in functional textiles, and a polymer membrane that can be obtained in accordance with the method according to the invention.

2. Description of Related Art

Polymer membranes of the above-mentioned type are used in a variety of fields of industrial, pharmaceutical or medical applications.

Membrane-based separation processes are gaining increasing importance, since these processes offer the advantage that the substances to be separated are not heat-stressed or even damaged. In this connection, microfiltration and ultrafiltration membranes make it possible to remove fine particles or microorganisms with sizes up to the submicron range and are therefore suitable, for example, for the production of purified water for use in laboratories or for the semiconductor industry. Numerous other applications of membrane-based separation processes are known from the beverage industry, for example for clarifying beverages, biotechnology or waste water technology, for example for treating process waste water or for separating digestates, as well as for purifying waste water of all types. Additional possible applications are oil/water separation, pervaporation, gas and vapor permeation, and solid/liquid separation in general. Moreover, use as a water-permeable and water-vapor-permeable carrier material is possible, for example for mechanical stabilization of membranes.

In order to be able to perform the filtration quickly, effectively, and economically, high (through) flow rates of the permeate with the lowest possible pressure differentials over the membrane must be achieved. In this case, known commercially available microfiltration membranes make possible flow rates in the range of approximately 100 l/(m²h bar). In addition, thermal stability and chemical stability are required in order to be able to use the membrane in a wide temperature and pH range. This is also of decisive importance for, i.a., the cleanability of the membranes by acids, lyes or other chemicals. Typical materials, from which filter membranes are produced, are, for example, polytetrafluoroethylene (PTFE), polyvinylidene fluoride (PVDF), polysulfone (PSU) or polypropylene (PP), whereby the above-mentioned list is not exhaustive.

In the textile industry, polymer membranes of the above-mentioned type are also used, for example for use in functional textiles, which make it possible for water vapor to escape from the inside to the outside by permeation.

The membrane materials that are usually used for the production of polymer membranes of the type in question, such as, for example, PTFE, PVDF and PP, are hydrophobic. This has the drawback that liquids with high surface tension, such as, for example, water, do not wet the pores of the membrane and therefore cannot penetrate the membrane. In order to be able to use the membranes, for example for membrane filtration, the latter must therefore be hydrophilized. From the state of the art, it is known to pre-wet ultrafiltration membranes or microfiltration membranes by suitable water-soluble substances, such as, for example, glycerol, glycerol stearates, glycerol esters or other alcohols or esters. When incorporating the membrane into a membrane-based separation unit, the membrane is then flushed for a specific time with water in order to wash out the pre-wetting agent successively from the inside space of the pores. This has the drawback that the membrane then must not dry out, since the membrane can no longer be wetted again by water after being purged of the pre-wetting agent. Moreover, this process of the “run-in” of the membrane is associated with a considerable expenditure of time and labor, which increases the costs of the membrane-based separation.

Methods for hydrophilizing a polymer membrane in a subsequent process step after the production of the membrane film are already known from the state of the art.

In German Patent Application DE 37 12 491 A1, for example, the hydrophilization of membranes by treatment with an air or oxygen plasma is described.

German Patent Application DE 38 35 612 A1 and corresponding U.S. Pat. No. 4,851,121 relate to a method for hydrophilization of a membrane, whereby the membrane is coated with a hydrophilic monomer, for example, with a sulfone with terminal olefin groups, and whereby the monomer is then polymerized on the surface of the membrane.

Moreover, the hydrophilization of a polyolefin membrane by plasma-induced grafting of a hydrophilic substance or suitable precursors, which are reacted in additional reaction steps to form hydrophilic side groups, is known from U.S. Pat. No. 6,765,069 B2.

From U.S. Pat. No. 5,476,590, it is already known to hydrophilize a hydrophobic PVDF membrane by reaction with dithionite, glucosamine hydrochloride, and/or hydrogen peroxide.

The above-mentioned methods for subsequent hydrophilization of polymer membranes, such as, for example, by plasma treatment, by irradiation or by wet-chemical polymerization on the membrane surface, are expensive as far as processing is concerned and cannot be performed or can be performed only at high costs on the industrial scale.

### SUMMARY OF THE INVENTION

The object of this invention is to provide a method of the above-mentioned type, which allows production of hydrophilic polymer membranes that is simple and economical as far as processing is concerned, even on an industrial scale. The membranes according to the invention are to be able to be used especially advantageously for microfiltration or ultrafiltration and make possible the filtration at high flow rates. In this case, the membranes according to the invention are to have a good capacity for moisture uptake and are to be penetrable even by liquids with high surface tension, in particular by water, at high flow rates.

To achieve the above-mentioned object, it is proposed according to the invention to admix at least one hydrophilization additive, and, optionally, at least one additional aggregate, into an especially hydrophobic polymer membrane starting material for membrane production or to introduce same into the membrane material, whereby the membrane material that has the hydrophilization additive and optionally the additional aggregate is extruded to form a polymer film that is charged with the hydrophilization additive and optionally the additional aggregate, and whereby the polymer film is then stretched in particular in a monoaxial and/or biaxial manner for pore formation.

### BRIEF DESCRIPTION OF THE DRAWING

The sole FIGURE of the drawing is a flow chart of the steps for producing a microfiltration membrane in accordance with the present invention.

### DETAILED DESCRIPTION OF THE INVENTION

The intrinsic hydrophilization that is provided according to the invention has numerous advantages relative to the method known from the state of the art for subsequent hydrophilization of polymer membranes. In this case, it is essential to the invention that the hydrophilizing agent or additive is introduced before or during the production of the actual membrane or the polymer film into the polymer membrane material, which represents the starting material for the membrane production. The addition of the hydrophilization additive can be carried out before or during the film extrusion of the membrane material. The hydrophilization additive can be introduced in a one-stage method into the membrane material, which requires a low processing cost and thus allows the economical production of the membrane.

Moreover, it is not necessary to “run in” the membrane according to the invention in order to increase the wettability of the membrane, which leads to time and cost advantages for the end user.

The mixing of the hydrophilization additive into the polymer membrane material in the melted state of the membrane material results in a permanent intrinsic hydrophilization. This means that in contrast to the state of the art, the hydrophilizing agent does not wash away from the surface of the membrane over time or can be washed out from the pores of the membrane. The membrane according to the invention is therefore distinguished by a long durability or service life. At the same time, the expenditure for maintenance and repairs drops when using the membrane in a membrane-based separation unit. Drying-out the membrane according to the invention is easily possible, without impairing or even losing the hydrophilic properties of the membrane. Moreover, flow rates>100 l/(m²h bar) and in particular greater than 150 l/(m²h bar) are easily achievable with such a membrane.

The hydrophilization additive can be an (amphiphilic) surfactant, in particular an anionic, cationic, non-ionic or cationic-anionic surfactant. By using the above-mentioned additives, a very effective intrinsic hydrophilization is possible at low cost. Suitable hydrophilizing agents are amphiphilic substances and surfactants with a molecular weight of less than 100,000 Daltons, which can be mixed with the starting polymer that is used.

In the case of an advantageous embodiment of the method according to the invention, an amphiphilic hydrophilization additive is used, which has at least one alkyl, acyl, aryl and/or arylacyl radical, coupled with a heteroatom-containing group, in particular from the group of glycols, polyoxyethylenes, sulfides, sulfonates, amines, amides, phosphonates and/or phosphates. Such hydrophilization additives can be present in the form of master-batches or granulates, which have different compositions.

It has been shown to be especially advantageous when a hydrophilization additive with the general composition CH₃CH₂—(CH₂CH₂)x-(OCH₂CH₂)y-OH is used, whereby x and y usually can attain values of between 1 and 20. Examples in this respect are the products Irgasurf®HL562 (Ciba Speciality Chemicals) and Unithox™550 (Baker Hughes). As an alternative, perfluoroalkyl compounds with an anionic methacrylate end group can be used as hydrophilization additives. ZONYL®7950 (DuPont Speciality Chemicals) belongs to such hydrophilization additives. Similar compounds, which instead contain acrylate, phosphate, or amine end groups, can also be used.

The membrane according to the invention can contain between 0.1 and 20% by weight of at least one suitable hydrophilization additive, preferably between 0.5 and 15% by weight, and especially preferably between 1 to 10% by weight of the hydrophilization additive.

The production method according to the invention, which is based on the extrusion and extension of polymer films, also allows, in a simple way, the addition of additional additives before or during the extrusion of the polymer starting material that is used. In particular, the method according to the invention opens up the possibility of admixing fillers in a simple way into the membrane material in order to achieve specific separating properties of the membrane.

The merging of membrane material and filler can be provided at the same time with the admixing of the hydrophilization additive into membrane material or after the admixing of the hydrophilization additive. The incorporation of the hydrophilization additive and the filler as well as optionally additional aggregates in the membrane material is preferably done by melt mixing. By mixing in at least one filler, economical microfiltration and ultrafiltration membranes can be produced, whereby inexpensive standard polyolefins can be used, no organic additives such as solvents are used, and film extrusion and stretching can preferably be done continuously and in particular inline at high speed on a motor-driven assembly line. The method according to the invention can provide the use of different polymer membrane materials as starting substances for the membrane production and the use of different fillers and optionally additional aggregates over broad concentration ranges. As a result, the separating properties of the filtration membranes that can be obtained in accordance with the method according to the invention and that are determined by, for example, the pore diameter, the porosity, the chemical, thermal or pH stability, the colors and (through-) flow rates are modified to adapt the separating properties in a targeted manner to a specific separating object.

By the selection of specific polymer membrane materials as starting substances for the membrane production and different fillers and optionally additional aggregates and by variation of the concentrations of the starting substances, fillers and additional aggregates used, the separating properties of the membrane can be set in such a way that the membranes according to the invention can be used especially advantageously for the filtration of aqueous waste water or process water, for beverage filtration or sterile filtration, for oil/water separation, as well as for the filtration of acids, lyes or other chemicals. The above-mentioned list is not exhaustive. The method according to the invention is also not limited to the production of filter membranes, but rather also allows, for example, the production of porous polymer membranes, which are used as a component of functional textiles or breathable textiles.

The extruded and elongated polymer film can have a filler in a concentration of between 20 and 90% by weight, preferably between 30 and 80% by weight, and especially preferably between 40 and 70% by weight, in each case relative to the total weight of the polymer film. In addition, the invention comprises microfiltration membranes, which contain an especially hydrophilic filler with a concentration of between 10 and 90% by weight, preferably between 30 and 80% by weight, and especially preferably between 40 and 70% by weight, and at least one hydrophilization additive with a concentration of between 0.1 and 15% by weight, preferably between 0.5 and 10% by weight, and especially preferably between 0.5 to 8% by weight. In terms of the invention, hydrophilic fillers are defined in particular as all fillers that are suitable to increase the wettability of the polymer by polar interactions with water. To this end, in particular inorganic fillers of an ionic and non-ionic nature are suitable, as well as all particles that have a permanently polar surface because of surface modification. Conceivable hydrophilic fillers are, for example, silicic acids, salts, or correspondingly surface-modified polymer particles.

For the production of the polymer films or polymer membranes according to the invention, in principle any extrudable polymers or polymer mixtures can be used as a polymer membrane material. Economical standard polymers are preferably used, such as polyolefins and their copolymers, such as, for example, highly-branched polyethylene or low-density polyethylene (LDPE), linear polyethylene of low density (LLDPE), polypropylene or polypropylene-heteropolymers. In particular, at least one substance of the membrane material is selected from the group of

Polyolefins;

(ii) Copolymers of polyolefins;

(iii) Mixtures of polyolefins and their copolymers; and

(iv) Polymer mixtures, comprising at least 10% by weight of polyolefins and/or their copolymers, relative to the polymer mixture.

Introducing the hydrophilization additive and optionally filler into the polymer membrane material can be done by batch or intermittently in a batch process. In order to further simplify the method according to the invention and to reduce process costs, the admixing to the polymer is preferably carried out, however, by inline compounding, for example in a twin-screw extruder or co-kneader, namely a single-screw extruder, which executes both a rotating movement and a back-and-forth movement. When the hydrophilization additive and optionally filler are introduced, the particulate aggregates are embedded in a polymer matrix and thus are immobilized, distributed as much as possible, in the membrane material.

After the admixing of the hydrophilization additive and optionally a filler as well as optionally additional aggregates, or simultaneously with the admixing, the polymer membrane material is extruded to form a polymer film. In the case of the film extrusion, different die geometries can be used, for example flat-sheet dies, in particular of the so-called “coat hanger” type, or round dies, whereby flat-sheet dies are preferred. Also, the production of blow-extrusion films is possible by extrusion.

If necessary, at least two plastic melts having different amounts of at least one filler and/or different aggregates, such as different hydrophilization additives and fillers, can be coextruded to form a polymer film. Aggregate-free and aggregate-containing plastic melts can also be coextruded to form a polymer film. In this case, in terms of the invention, the term “coextrusion” is defined as the merging of similar or dissimilar plastic melts before leaving the profile die of the extruder. Multiple-layer polymer films can be produced by coextrusion, whereby, for example, a filler-containing functional layer can be produced with one or more cover layers with deviating filler content or with another type of filler. The cover layers can be used, for example, for mechanical, thermal or chemical stabilization of the polymer film to improve the gluability or weldability of the microfiltration membrane according to the invention, or to produce porosity gradients within the microfiltration membrane.

Before the stretching, the thickness of the extruded polymer film is preferably between 5 and 300 μm, more preferably between 20 and 250 μm, and especially preferably between 30 and 200 μm. Subsequently, there is then another thickness reduction by the stretching or elongation of the polymer film.

The extruded polymer film is elongated or stretched in a monoaxial or biaxial manner according to the invention in at least one subsequent process step, which results in pore formation. During the stretching, holes, which form pores of the membrane, pull in particular at the boundary between the filler particles and the polymer matrix. The elongation or stretching can preferably be carried out inline, for example monoaxially, in an elongating unit that consists of several pairs of rollers. As a result, continuous production of a polymer membrane according to the invention at high speed on a machine segment is possible, which contributes to low production costs. As an alternative, monoaxial or biaxial offline stretching, for example in a stretcher, is also possible.

As filler, in particular an inorganic filler is suitable, in addition in particular from the group of carbonates, preferably calcium carbonate, magnesium carbonate, sodium carbonate or barium carbonate; and/or from the group of silicon dioxides and silicates, preferably magnesium silicate hydrate (talc), mica, feldspar or glasses; and/or from the group of sulfates, preferably calcium sulfate, magnesium sulfate, barium sulfate, or aluminum sulfate. As an alternative or in addition, an organic filler, in particular from the group of polymers, can be admixed into the polymer membrane material. It is understood that mixtures and combinations of the above-mentioned groups and compounds can also be used as filler(s). As filler, calcium carbonate in the form of calcite (lime spar) and/or aragonite, in particular as natural rock in the form of limestone or chalk, is especially preferably admixed. By using the last-mentioned fillers, microfiltration membranes can be produced with excellent separating properties. In particular, the thus obtained microfiltration membranes are distinguished by high flow rates and low raw material costs.

One embodiment of the invention relates to a polymer film with 40 to 70% by weight of calcium carbonate, 1 to 10% by weight of a hydrophilization additive, and 20 to 59% by weight of PP, LDPE, or LLDPE as well as mixtures of the latter.

In principle, particulate fillers with a mean particle diameter of less than 10 μm, preferably 0.1 to 8 μm, and especially preferably 1 to 5 μm, are suitable. Based on the filler that is used, the amount of filler, and/or the particle size, the separating properties of the microfiltration membrane according to the invention can change in a variety of ways and can be adapted to the separating object. Thus, for example, the porosity, the pore diameter, the heat conductivity, and the electrical conductivity of the microfiltration membranes according to the invention can be set and preset within a wide range.

During the stretching of the polymer film, the temperatures can lie between 20° C. and 180° C. below the melting point or softening point of the matrix polymer or membrane material that is used, preferably between 40 and 120° C., and especially preferably between 50° C. and 110° C., below the melting point or softening temperature. The method according to the invention is thus distinguished by moderate operating temperatures during stretching, which simplifies the method and further reduces the production costs of the membrane according to the invention.

The stretching can be performed by a factor of between 1.5 and 7, preferably between 2 and 5, and especially preferably between 2 and 4. As a result, the thickness of the membrane and the separating properties, in particular the desired pore size, can vary within wide ranges and can be adapted to a specific separating object.

The membrane that can be obtained in accordance with the method according to the invention makes possible in particular the filtration at high flow rates, whereby when using tap water, flow rates of at least 100 l/(m²h bar), preferably at least 130 l/(m²h bar), and especially preferably at least 150 l/(m²h bar) are achieved. Higher flow rates are possible and are advantageous. The microfiltration membranes according to the invention can have pore sizes in a range of 0.1 to 5 μm, preferably in a range of 0.1 to 2 μm, and especially preferably in a range of between 0.2 and 1 μm. The porosity of the membrane according to the invention, i.e., the ratio of the hollow space volume to the total volume, is in this case at least 30%, preferably at least 40%.

### EXAMPLES

This invention is described in more detail by the preferred embodiments below, which in no way limit this invention, however. The properties indicated in the preferred embodiments were determined with the following test methods. The measurement of the flow rate was done with a membrane test stand (“Memcell,” Osmo Membrane Systems), in which the membrane in the cross-current method was exposed to pressures of 0.1 to 64 bar. The permeate was collected, and the flow rate was calculated from the permeate amount per minute. All flow rates were standardized to the unit l/(m²h bar). As a concentrate, a one-percent titanium dioxide suspension with a mean particle diameter of 0.5 μm was used. The success of the membrane filtration allowed optical confirmation based on clear permeate.

### Example 1

LLDPE was used as a polymer membrane material for the production of a polymer film. Chalk as a filler with a mean particle diameter of approximately 2 μm and a hydrophilization additive (Unithox™ 550—Baker Hughes) were admixed into the membrane material. Then, the thus obtained mixture was extruded for forming the polymer film. The polymer film had a proportion of 65% by weight of chalk, 5% by weight of hydrophilization additive, and 30% by weight of LLDPE. The thickness of the polymer film was 90 μm. The polymer film was stretched by a factor of 3.6 at 70° C. The thickness of the polymer film was then 25 μm. The flow rate of the membrane at a pressure differential of 0.25 bar was 810 l/(m²h bar), and the permeate was free of turbidity.

### Example 2

PP was used as a polymer membrane material for the production of a polymer film. Chalk as filler with a mean particle diameter of approximately 1.4 μm and a hydrophilization additive Irgasurf®HL562 (Ciba Speciality Chemicals) were admixed into the starting material. Then, the thus obtained mixture was extruded for forming the polymer film. The polymer film had a proportion of 60% by weight of chalk, 8% by weight of hydrophilization additive, and 27% by weight of PP. The thickness of the polymer film was 150 μm. The polymer film was stretched by a factor of 3.5 at 95° C. The thickness of the polymer film was then 47 μm. The flow rate of the polymer film at a pressure differential of 0.75 bar was 310 μl/(m²h bar), and the permeate was free of turbidity.

### Example 3

A polymer mixture of LLDPE and LDPE was used as a polymer membrane material for the production of a polymer film. Barium sulfate as filler with a mean particle diameter of approximately 5 μm and a hydrophilization additive (Unithox™550—Baker Hughes) were admixed into the membrane material. Then, the thus obtained mixture was extruded for forming the polymer film. The polymer film had a proportion of 55% by weight of barium sulfate, 5% by weight of hydrophilization additive, 30% by weight of LLDPE, and 10% by weight of LDPE. The thickness of the polymer film was 120 μm. The polymer film was stretched by a factor of 3 at 90° C., and the thickness of the polymer film was then 43 μm. The flow rate of the polymer film at a pressure differential of 0.5 bar was 230 l/(m²h bar), and the permeate was free of turbidity.

### Example 4

A polymer mixture of LLDPE and LDPE was used as a polymer membrane material for the production of a polymer film. Mica as filler with a mean particle diameter of approximately 8.5 μm and a hydrophilization additive (ZONYL® 7950—DuPont Specialty Chemicals) were admixed into the membrane material. Then, the thus obtained mixture was extruded for forming the polymer film. The polymer film had a proportion of 50% by weight of mica, 4% by weight of hydrophilization additive, 16% by weight of Linear Low Density Polyethylene (LLDPE), and 30% by weight of Low Density Polyethylene (LDPE). The thickness of the polymer film was 120 μm. The polymer film was stretched by a factor of 4 at 60° C.; the thickness of the polymer film was then 29 μm. The flow rate of the polymer film at a pressure differential of 0.25 bar was 875 l/(m²h bar), and the permeate was free of turbidity.

The invention allows the features that are mentioned in the claims and/or described above, in particular in the embodiments, to be combined with one another, even if the combination is not described in detail. The above indications of value and the indicated intervals in each case encompass all values, i.e., not only the lower limits or, in the case of intervals, the interval limits, without the latter requiring express reference.

Below, a variant embodiment of a method according to the invention for the production of a microfiltration membrane is explained in the example of the FIGURE. The invention is not limited to the depicted variant embodiment. If necessary, features of the depicted variant embodiment can be combined with the above-described features and/or the features mentioned in the claims.

The single FIGURE diagrammatically shows the process sequence of a method for the production of a polymer membrane 1. In a first process step a, the depicted method calls for at least one hydrophilization additive 3 to be admixed into a polymer membrane material 2, which represents the starting material of the membrane production. As a result, it can be achieved that liquids with high surface tension, such as, for example, water, wet the pores of the polymer membrane 1 and can penetrate the polymer membrane 1 at high flow rates, which is then in particular of importance when a hydrophobic membrane material 2, such as, for example, PTFE, PVDF and PP, is used as starting material for the membrane production. In the mixture, the membrane material 2 forms a polymer matrix for the hydrophilization additive 3. The membrane material 4 that is obtained in the process step a and that has the hydrophilization additive 3 is then extruded in a process step b to form a polymer film 5. The mixing of the hydrophilization additive 3 into the membrane material 2 and the extruding of the polymer film 5 can be done by inline compounding by means of a double-screw extruder or the same mixing device.

The polymer film 5 is stretched in a monoaxial or biaxial manner in a third process step c for pore formation, which can also be done inline in an elongating unit that is downstream from the extruding device.

Preferably, it can be provided to admix at least one filler 6 into the membrane material 2 in addition to the hydrophilization additive 3. By selecting at least one suitable filler 6 and/or by determining a specific amount of filler, the properties of the polymer membrane 1 that is produced can be changed so that the latter is suitable as a microfiltration or ultrafiltration membrane. In this case, the membrane production is economically possible, since inexpensive standard polyolefins can be used, no organic additives such as solvents are necessary, and the method makes it possible to perform the film extrusion and the stretching of the polymer film 5 continuously and inline at high speed on a single machine segment. During the stretching, holes, which form the pores of the polymer membrane 1 and equip the latter with the necessary separating properties, pull at the boundary between the filler particles and the polymer matrix.

What is claimed is:

1-12. (canceled)

13. Method for the production of a hydrophilic polymer membrane, comprising the steps of:
using at least one hydrophilization additive as starting material for the membrane production and, admixing it into a hydrophobic polymer membrane material,
extruding the membrane material with the admixed hydrophilization additive to form a polymer film that is charged with the hydrophilization additive, and
stretching the polymer film in at least one of a monoaxial and a biaxial manner to form pores.

14. Method according to claim 13, wherein at least one substance of the membrane material is selected from the group consisting of:
(i) Polyolefins;
(ii) Copolymers of polyolefins;
(iii) Mixtures of polyolefins and their copolymers; and
(iv) Polymer mixtures, comprising at least 10% by weight of at least one of polyolefins and their copolymers, relative to the polymer mixture.

15. Method according to claim 13, wherein the hydrophilization additive is admixed in such a way that intrinsic hydrophilization is carried out.

16. Method according to claim 13, wherein hydrophilization additive is at least one of an amphiphilic hydrophilization additive and a surfactant.

17. Method according to claim 13, wherein the hydrophilization additive is an amphiphilic hydrophilization additive that has at least one of an alkyl, acyl, aryl and arylacyl radical, coupled to a heteroatom-containing group selected form the group consisting of glycols, polyoxyethylenes, sulfides, sulfonates, amines, amides, phosphonates and phosphates.

18. Method according to claim 13, wherein the hydrophilization additive in the polymer film constitutes 0.1 to 20% by weight,

19. Method according to claim 13, wherein the hydrophilization additive in the polymer film constitutes 1.0 to 10% by weight.

20. Method according to claim 13, wherein, before or during the extruding step, an aggregate filler is admixed into the membrane material in an amount constituting 20% to 90% by weight of the polymer film.

21. Method according to claim 13, wherein, before or during the extruding step, an aggregate filler is admixed into the membrane material in an amount constituting 40% to 70% by weight of the polymer film.

22. Method according to claim 13, wherein at least one hydrophilic filler is admixed along with said at least one at least one hydrophilization additive into the membrane material in amounts producing a concentration of the filler in the polymer film of 10% to 90% by weight and a concentration of the hydrophilization additive in the polymer film of 0.1% to 15% by weight.

23. Method according to claim 13, wherein an filler selected from at least one of the groups of carbonates, silicon dioxides and silicates, polymers, and a mixture or combination of said groups is added as a filler.

24. Method according to claim 23, wherein the filler has a mean particle diameter of less than 10 μm.

25. Method according to claim 13, wherein said stretching is performed at a temperature between 20° C. and 180° C. below the melting point and the softening point of the polymer membrane material

26. Method according to claim 25, wherein the stretching is carried out by a factor of between 1.5 and 7.

27. Method according to claim 13, wherein the stretching is carried out by a factor of between 1.5 and 7.

28. Method according to claim 13, wherein a porous membrane for filtration is produced by said steps.

29. Method according to claim 13, wherein a porous membrane for use in functional textiles is produced by said steps.

30. Method according to claim 13, wherein at least one additional aggregate is admixed along with said at least one hydrophilization additive into the hydrophobic polymer membrane material.

31. Polymer membrane that can be obtained by a method according to claim 13.
